(19) United States
(12) Patent Application Publication
(10) Pub. No.: US 2008/0065497 A1
(43) Pub. Date: Mar. 13, 2008

(54) SALES PROCESSING METHOD AND APPARATUS

(75) Inventor: Masakazu Itoh, Kanagawa (JP)

Correspondence Address: YOUNG & THOMPSON, 745 SOUTH 23RD STREET, 2ND FLOOR, ARLINGTON, VA, 22202, US

(73) Assignee: NEC INFRONTIA CORPORATION, KANAGAWA (JP)

(21) Appl. No.: 11/850,698

(22) Filed: Sep. 6, 2007

(30) Foreign Application Priority Data
Sep. 7, 2006 (JP) 2006-242759

(51) Int. Cl. G06Q 20/00; G06F 17/30; G07G 1/01; G07G 1/12; G06F 17/40

(52) U.S. Cl. 705/18

(57) ABSTRACT

A sales processing method for storing an order received from a customer in a storage as a pending order, recalling the pending order from the storage to display the pending order when payment is made, and executing checkout processing to book the pending order as sales data, includes: when the pending order is stored, storing information identifying a person-in-charge associated with the pending order in the storage in association with the pending order; and, when an instruction to execute processing of the pending order stored in the pending data storage is issued, determining whether or not an operator who has issued the instruction to execute the processing matches the person-in-charge associated with the pending order and, if the operator matches the person-in-charge, enabling execution of the processing.

This application is based upon and claims the benefit of priority from Japanese patent application No. 2006-242759, filed on Sep. 7, 2006, the disclosure of which is incorporated herein in its entirety by reference.

### BACKGROUND OF THE INVENTION

1. Field of the Invention

The present invention relates to sales processing at stores and shops, including retail stores, restaurants and the like, in particular, to a sales processing method in a cash register or a POS (Point Of Sales) terminal device including the capability of holding orders and to a processing apparatus implementing the method.

2. Description of the Related Arts

When a sales processing apparatus is used at a restaurant or the like, for example, order intake data obtained from orders received from customers is held as pending data and checkout processing based on the pending data is performed upon payment (i.e., checkout) when the customers leave the restaurant, because orders from customers are frequently added or canceled.

In the following description, order intake information obtained when a shop or restaurant staff member has received an order from a customer is referred to as order intake data, order intake data recorded temporarily until payment is referred to as pending data, and pending data after payment is referred to as sales data.

Japanese Patent Laid-Open No. 09-282562 (JP-A-9-282562) discloses a cash register installed and used at a restaurant as a terminal apparatus in which data about an order from a customer is inputted and settlement processing of that relevant order data is performed by inputting payment data based on payment by the customer. Japanese Patent Laid-Open No. 11-110648 (JP-A-11-110648) discloses a POS system used at a restaurant or the like that allows pending data to be shared easily between a master device and slave devices. Japanese Patent Laid-Open No. 2006-127044 (JP-A-2006-127044) discloses a technique that facilitates sales processing for a group of many people seated at more than one table.

Sales processing based on the related art performed at a shop such as a restaurant will be described below. FIG. 1 shows an exemplary configuration of a sales processing apparatus such as a cash register or a POS terminal apparatus.

The sales processing apparatus is an information processing apparatus which has typical information processing capabilities and includes: input device 101 such as a keyboard, a touch screen, or a ten-key pad; screen display 102; printer 103; controller 104 including a CPU (Central Processing Unit) as its main component; program storage 105 storing programs and the like; pending data storage 106; and sales data storage 107. These components 101 to 107 are interconnected through a bus.

At the restaurant, an order slip is provided to a customer when or after a dish or drink is delivered in response to an order from the customer. When checkout is performed for the customer, typically a staff member acts as an operator of the sales processing apparatus who inputs the slip number contained on the order slip presented by the customer in input device 101 to cause the sales processing apparatus to perform processing for recalling pending data. As a result, the order intake data held in pending data storage 106, that is, the pending data, is displayed on screen display 102. The operator checks the pending data to see whether the data matches and then receives cash or performs other checkout processing.

In some operation modes, orders separately placed by a customer are integrated into a single order slip. In such a case, a pending issue number is assigned to the order each time an order is held, and processing for recalling pending data is then performed on the basis of the pending issue number.

FIG. 2 shows an exemplary procedure performed by controller 104 in the sales processing apparatus shown in FIG. 1 during checkout for a customer.

Controller 104 accepts an input of “Pending data recall” from input device 101 using an order slip number at step 111, and searches pending data storage 106 for pending data at step 112 by using the accepted order slip number. At step 113, controller 104 recalls the pending data associated with the order slip number (or pending issue number) used for the search from pending data storage 106 and displays the pending data on screen display 102.

Then, the operator compares the pending data displayed with the order slip presented by the customer to see whether they match. If they match, the operator depresses a “Checkout” button on input device 101 to cause the sales processing apparatus to perform checkout processing.

Controller 104 determines at step 114 whether the “Checkout” button has been depressed to input a checkout instruction. If a checkout instruction is received, controller 104 performs checkout processing for settlement of the sales on the basis of the pending data recalled and sales registration processing for registering the settled pending data in sales data storage 107 as sales data at step 115. The result of the checkout processing is outputted from printer 103.

On the other hand, if the order slip is checked with the data on the display in the procedure described above but a checkout instruction is not issued at step 114, it means that cancellation or addition of an order is to be made rather than payment. Therefore, controller 104 performs given order change processing at step 116 in accordance with an input from input device 101 and records the changed data in pending data storage 106 as pending data. Especially if an operation mode is used in which pending orders are integrated into a single order slip, it is possible that an order slit itself has not yet been issued at the time when an order is canceled or added by a customer and therefore a pending issue number must be used to perform processing for recalling pending data.

In the related art, as described above, when order change processing or checkout processing is performed on pending data, the operator inputs an order slip number or a pending issue number or displays a list of pending data and selects relevant data from the list, thereby retrieving pending data to be processed from the pending data storage (pending buffer) to display the data on a sales screen on the display of the sales processing apparatus. This operation is called “recall”. Then, processing for adding sales, i.e., the order change processing, or checkout processing is performed on the recalled pending data.

In the system of the related art described above, operation for recalling pending order can be performed by any staff member or operator regardless of whether the staff member or operator is a person in charge of the customer. However, depending on the mode of service operation at a place such as a restaurant, orders may be classified by person-in-charge. In other words, a staff member may enter only orders placed by customers or at tables of which the staff member is in charge. In such an operation mode, allowing staff members other than a actual person-in-charge to access the pending order information is problematic in security terms and can lead to accidental recalling of a pending order entered by another person-in-charge. This problem has impaired secure and reliable sales processing operation at stores and shops such as restaurants.

### SUMMARY OF THE INVENTION

Therefore, an object of the present invention is to provide a sales processing method suitable for a mode in which orders are classified by each person-in-charge at an outlet such as a store, shop, restaurant and the like, and capable of preventing wrong access to information of another person-in-charge.

Another of the present invention is to provide a sales processing apparatus suitable for a mode in which orders are classified by each person-in-charge at an outlet such as a store, shop, restaurant and the like, and capable of preventing wrong access to information of another person-in-charge.

According to a first exemplary aspect of the present invention, there is provided a sales processing method for storing an order received from a customer in a data storage as a pending order, recalling the pending order from the data storage to display the pending order when payment is made, and executing checkout processing to book the pending order as sales data, including: when the pending order is stored, storing information identifying a person-in-charge associated with the pending order in the data storage in association with the pending order; and, when an instruction to execute processing of the pending order stored in the data storage is issued, determining whether or not an operator who has issued the instruction to execute the processing matches the person-in-charge associated with the pending order and, if the operator matches the person-in-charge, enabling execution of the processing.

According to a second exemplary aspect of the present invention, there is provided a sales processing apparatus including: a data storage for storing an order received from a customer as a pending order; a screen display on which, when payment is made, the pending order recalled from the data storage; and a controller which, when the pending order is stored, stores information identifying a person-in-charge associated with the pending order in the data storage in association with the pending order and, when an instruction to execute processing of the pending order stored in the data storage is issued, determines whether or not an operator who has issued the instruction to execute the processing matches the person-in-charge associated with the pending order and, if the operator matches the person-in-charge, enables execution of the processing.

According to a second exemplary aspect of the present invention, there is provided a sales processing apparatus including: storage means for storing an order received from a customer as a pending order; display means on which, when payment is made, the pending order recalled from the data storage; and control means which, when the pending order is stored, stores information identifying a person-in-charge associated with the pending order in the storage means in association with the pending order and, when an instruction to execute processing of the pending order stored in the storage means is issued, determines whether or not an operator who has issued the instruction to execute the processing matches the person-in-charge associated with the pending order and, if the operator matches the person-in-charge, enables execution of the processing.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram showing an exemplary configuration of a sales processing apparatus according to a related art;

FIG. 2 is a flowchart of a process performed when a slip number is input in the sales processing apparatus shown in FIG. 1;

FIG. 3 is a block diagram showing a configuration of a sales processing apparatus according to an exemplary embodiment of the present invention;

FIG. 4 is a diagram showing an exemplary data structure of pending order information;

FIG. 5 is a diagram showing an exemplary screen for entering an issue number;

FIG. 6 is a diagram showing an exemplary display of a pending order list;

FIG. 7 is a diagram showing an exemplary sales screen;

FIG. 8 is a flowchart showing an exemplary search process performed when a pending issue number is entered; and

FIG. 9 is a flowchart showing an exemplary process for displaying a pending order list.

### DETAILED DESCRIPTION OF EXEMPLARY EMBODIMENT

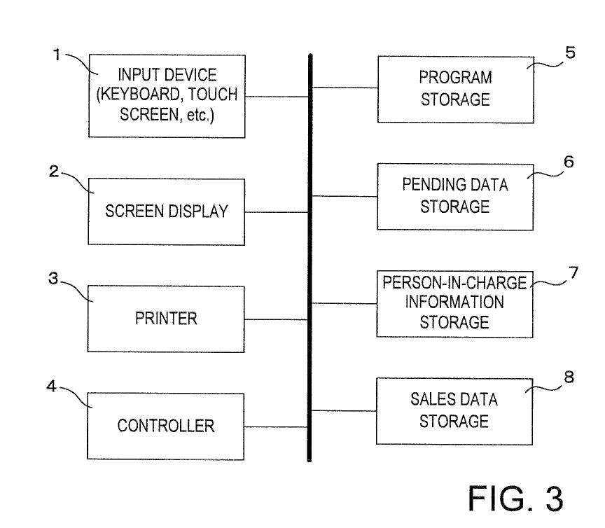

FIG. 3 shows a configuration of a sales processing apparatus according to an exemplary embodiment of the present invention. The sales processing apparatus includes input device 1, screen display 2, printer 3, controller 4, program storage 5, pending data storage 6, person-in-charge information storage 7, and sales data storage 8, which are connected onto a bus, and include the typical information processing capability of operating under the control of controller 4 in accordance with a program.

Input device 1 provides specification information entered by depression of a button on a keyboard, or touch of an image on a touch panel or display, or a combination of these to controller 4. Input device 1 includes keys such as a key for causing the sales processing apparatus, or POS terminal apparatus, to perform the recall processing described above, and a “Checkout” key.

Screen display 2 displays text, a document, or an image on the screen under the control of controller 4 according to the specification entered through input device 1. Some data or image is automatically displayed on the screen by controller 4 in accordance with a program stored in program storage 5. The display screen can be used as a touch panel and can also function as an input device using a mouse. Printer 3 is used for printing out an order slip and a receipt after payment. Controller 4 includes a CPU as a main component and a temporary working memory. In accordance with a program stored in program storage 5, controller 4 controls the components connected through the bus and executes the sales processing. Program storage 5 contains a program causing controller 4 to execute functions of sales processing and provides a program stored in it to controller 4 in response to a request from controller 4.

Pending data storage 6 stores unsettled order intake data, i.e., pending data, inputted by a person-in-charge through input device 1 under control of controller 4. Person-in-charge information storage 7 contains a database storing the person-in-charge number of each person-in-charge. It is assumed in this exemplary embodiment that a unique person-in-charge number is assigned to every staff member who can act as a person-in-charge in the shop. The name of a person-in-charge can be written on a receipt provided to a customer on payment. The name is reversely resolved from the person-in-charge number in person-in-charge information storage 7. Sales data storage 8 registers and stores settled sales data as a sales file under the control of controller 4.

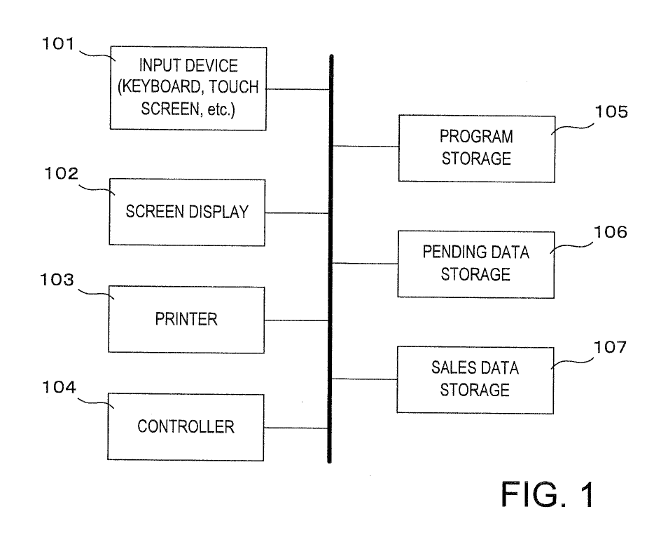

Like a sales processing apparatus shown in FIG. 1, the sales processing apparatus receives an order placed by a customer and stores the order as a pending order in pending data storage 6. However, the sales processing apparatus of the exemplary embodiment differs from the sales processing apparatus shown in FIG. 1 in that the sales processing apparatus of the exemplary embodiment contains information about a person-in-charge who has performed the holding processing, for example a person-in-charge number, in information about the pending order. The information about a pending order is hereinafter referred to as pending order information.

In the exemplary embodiment, when a pending order is recalled for changing or adding an order or checkout processing, the operator of the sales processing apparatus first logs in the sales processing apparatus and then inputs a pending issue number. At this time, if the person-in-charge number of the logged-in operator does not match the person-in-charge number contained in pending order information associated with the entered pending issue number, the pending order information is not allowed to be recalled. Moreover in the exemplary embodiment, when a list of pending orders is displayed on screen display 2, collation of the person-in-charge number is performed and only pending order information having the same person-in-charge numbers as that of the logged-in operator is displayed.

In the sales processing apparatus of this exemplary embodiment, when order intake data is to be stored in pending data storage 6 as pending data, controller 4 generates pending order information including the person-in-charge number of the current person-in-charge and stores it in pending data storage 6 so that, when the pending order information is recalled, the pending order information with the same person-in-charge number as that of the logged-in operator at that point in time can be retrieved from pending data storage 6.

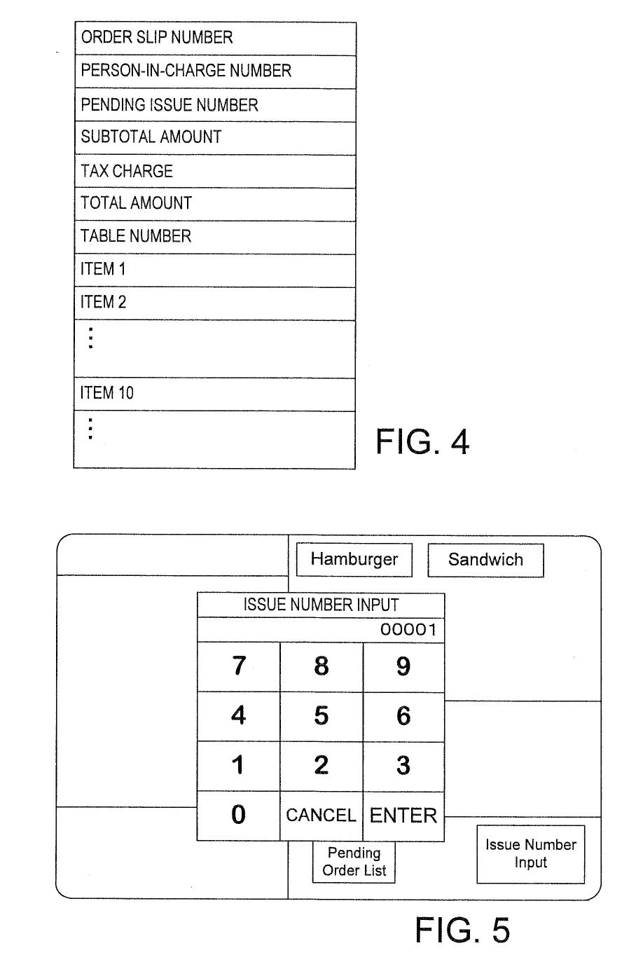

FIG. 4 shows an exemplary structure of pending order information stored in pending data storage 6. It can be seen that the pending order information includes a person-in-charge number in addition to a pending issue number. After checkout, data in the same format as that of the pending order information is stored in sales data storage 8 as sales data.

FIG. 5 shows an exemplary screen for recalling pending order information on the sales processing apparatus of the exemplary embodiment. When a key for requesting input of a pending issue number is depressed on input device 1 of the sales processing apparatus, an input screen as shown in FIG. 5 is displayed on screen display 2, on which a pending issue number can be input.

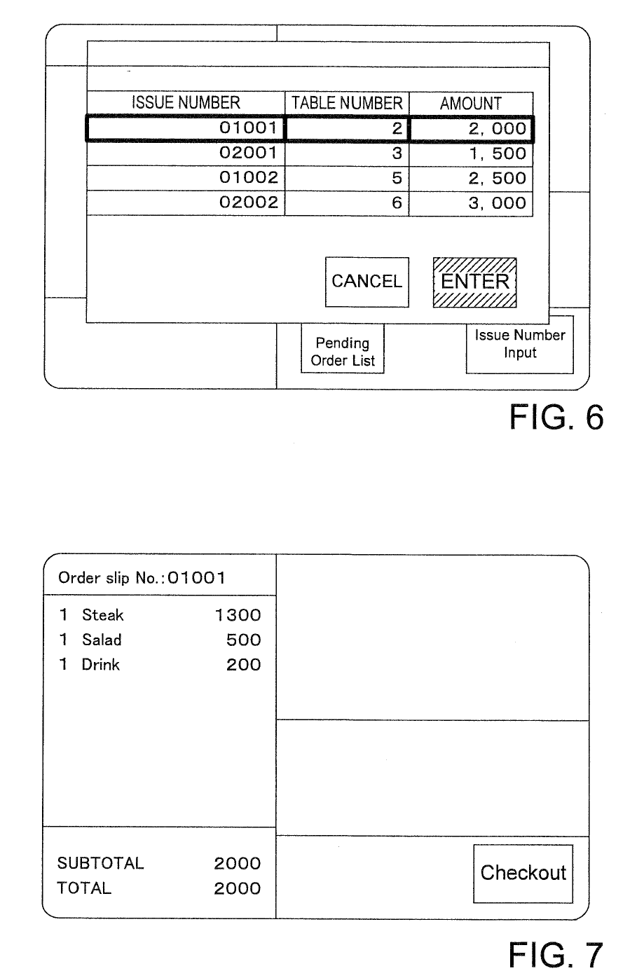

In this sales processing apparatus, when an “Pending order list” key is depressed on input device 1, data to be displayed is searched for and, as a result, pending order information with a matching person-in-charge number is displayed on screen display 2 as shown in FIG. 6. When one of listed entries of the pending order information is selected, pending data associated with the selected entry of pending order information is displayed on screen display 2 as a sales screen as shown in FIG. 7.

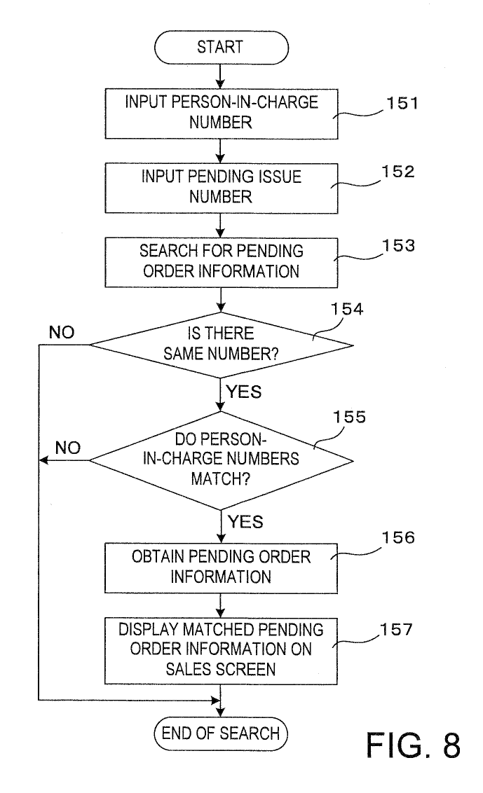

FIG. 8 shows an example of a process for recalling pending order information by inputting a pending issue number. An operator who wants to recall pending order information enters the operator's person-in-charge number at step 151. The person-in-charge number may be automatically inputted in response to a login operation on the sales processing apparatus. The operator then uses input device 1 to enter a pending issue number associated with the pending order information to search for at step 152. Controller 4 then searches for the pending order information stored in pending data storage 6 on the basis of the entered pending issue number at step 153 and determines at step 154 whether there is pending order information with the same pending issue number as the entered pending issue number. If the pending order information with the matching pending issue number is not found, the process will end. If pending order information with the matching pending order number is found, controller 4 determines at step 155 whether the person-in-charge number contained in the pending order information matches that of the current operator. If the person-in-charge numbers do not match, the process will end. If the person-in-charge numbers match, controller 4 retrieves the pending order information from pending data storage 6 at step 156, and then displays the pending order information on the sales screen on screen display 2 at step 157.

In this way, if the person-in-charge number of a logged-in operator does not match the person-in-charge number contained in pending order information associated with an input pending issue number, the exemplary embodiment prevents pending order information from being recalled.

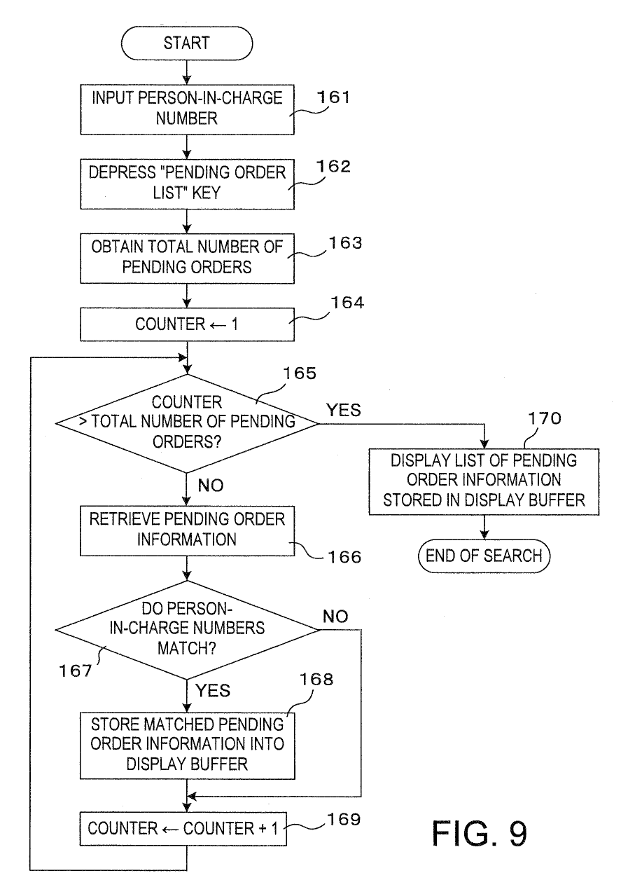

FIG. 9 shows an example of a process for displaying a pending order list. An operator who wants to display a pending order list first inputs the operator's person-in-charge number at step 161. The person-in-charge number may be automatically inputted in response to a login operation on the sales processing apparatus. The operator then depresses an “Pending order list” key on input device 1 at step 162 to instruct the sales processing apparatus to display a pending order list. Then controller 4 obtains the total number of pending orders stored in pending data storage 6 at step 163, assigns “1” to a counter at step 164, and then determines at step 165 whether the total number of the pending orders is greater than the value of the counter. If the value of the counter is less than or equal to the number of the pending orders, it means that there is pending order information that has not yet been retrieved. Therefore controller 4 searches for pending order information at step 166 to retrieve an entry of the pending order information that has not yet been retrieved from the pending data storage 6 and determines at step 167 whether the person-in-charge number contained in the retrieved pending order information matches the person-in-charge number which has been inputted at step 161. If they match, controller 4 stores the pending order information in a display buffer at step 168 and then proceeds to step 169. If the person-in-charge numbers do not match at step 167, the controller 4 does not store the pending order information in the display buffer and the process proceeds to step 169. At step 169, controller 4 increments the counter value by “1” and then returns to step 165.

If the value of the counter exceeds the total number of pending orders at step 165, it means that all entries of pending order information in the pending data storage 6 have been checked with the person-in-charge number. Therefore, controller 4 displays on screen display 2 a list of the pending order information currently stored in the display buffer at step 170, and then the process will end.

In this way, in the exemplary embodiment, when the “Pending order list” key is depressed, only the pending order information with the same person-in-charge number as that of the operator who depressed the “Pending order” key is listed.

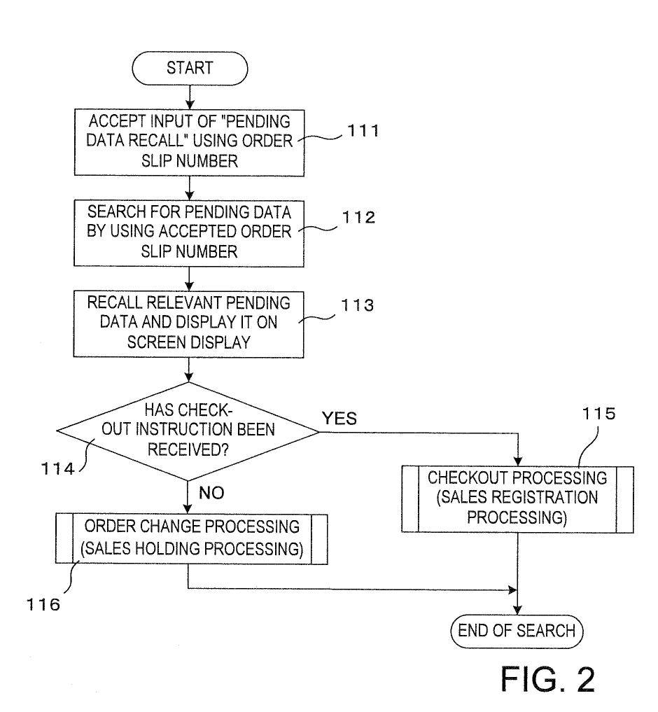

The sales processing apparatus described above enables checkout processing and sales registration processing, or processing of adding or changing an order to be performed as in the sales processing apparatus of the related art shown in FIGS. 1 and 2 when a person-in-charge recalls or displays a list of pending order information of which the person is in charge and then selects a desired entry of pending order information.

The sales processing method and apparatus described above are capable of preventing accidental access to pending order information by an irrelevant staff member, for example. Furthermore, the sales processing method and apparatus enable a person-in-charge to refer to a list of pending order information, that is, order slip information, of which the person is in charge, for example. Thus, the person can readily ascertain each pending order, and readily access pending order information of which the person is in charge.

While exemplary embodiments of the present invention have been described using specific terms, such description is for illustrative purposes only, and it is to be understood that changes and variations may be made without departing from the spirit or scope of the following claims.

What is claimed is:

1. A sales processing method for storing an order received from a customer in a storage as a pending order, recalling said pending order from said storage to display said pending order when payment is made, and executing checkout processing to book said pending order as sales data, comprising:
when said pending order is stored, storing information identifying a person-in-charge associated with said pending order in said storage in association with the pending order; and,
when an instruction to execute processing of said pending order stored in said storage is issued, determining whether or not an operator who has issued the instruction to execute the processing matches the person-in-charge associated with said pending order and, if the operator matches the person-in-charge, enabling execution of said processing.

2. A sales processing method for storing an order received from a customer in a storage as a pending order, recalling said pending order from said storage to display said pending order on a screen display when payment is made, and executing checkout processing to book said pending order as sales data, comprising:
when said pending order is stored, storing first person-in-charge information identifying a person-in-charge associated with said pending order in said storage in association with the pending order;
receiving second person-in-charge information identifying an operator attempting to cause processing for recalling said pending order stored in said storage to be executed from the operator;
when an instruction to execute processing for recalling a particular pending order stored in said storage is issued, determining whether or not said first person-in-charge information associated with and stored with the particular pending order matches said second person-in-charge information; and
if said first person-in-charge information matches said second person-in-charge information at said determination, performing said process for recalling said particular pending order to display said particular pending order on said screen display.

3. A sales processing method for storing an order received from a customer in a storage as a pending order, recalling said pending order from said storage to display said pending order on a screen display when payment is made, and executing checkout processing to book said pending order as sales data, comprising:
when said pending order is stored, storing first person-in-charge information identifying a person-in-charge associated with said pending order in said storage in association with the pending order;
receiving second person-in-charge information identifying an operator attempting to cause processing for displaying a list of said pending order stored in said storage to be executed from the operator; and
when an instruction to execute said processing for displaying is issued, selecting a pending order associated with said first person-in-charge information that matches said second person-in-charge information from said pending order stored in said storage and displaying a list of the selected pending order on said screen display.

4. A sales processing apparatus comprising:
a data storage for storing an order received from a customer as a pending order;
a screen display on which, when payment is made, said pending order recalled from said data storage; and
a controller which, when said pending order is stored, stores information identifying a person-in-charge associated with said pending order in said data storage in association with the pending order and, when an instruction to execute processing of said pending order stored in said data storage is issued, determines whether or not an operator who has issued the instruction to execute the processing matches the person-in-charge associated with said pending order and, if the operator matches the person-in-charge, enables execution of said processing.

5. The sales processing apparatus according to claim 4, further comprising a sales data storage in which said pending data is stored as sales data by executing checkout processing for the said pending data.

6. A sales processing apparatus comprising:
a data storage for storing an order received from a customer as a pending order;
a screen display on which, when payment is made, said pending order recalled from said data storage;
an input device; and
a controller which, when said pending order is stored, stores first person-in-charge information identifying a person-in-charge associated with said pending order in said data storage in association with the pending order; receives second person-in-charge information identifying an operator attempting to cause processing for recalling said pending order stored in said data storage to be executed from the operator; when an instruction to execute processing for recalling a particular pending order stored in said data storage is issued, determines whether or not said first person-in-charge information associated with and stored with the particular pending order matches said second person-in-charge information; and if said first person-in-charge information matches said second person-in-charge information at said determination, performs said process for recalling said particular pending order to display said particular pending order on said screen display.

7. The sales processing apparatus according to claim 6, further comprising a sales data storage in which said pending data is stored as sales data by executing checkout processing for the said pending data.

8. A sales processing apparatus comprising:
a data storage for storing an order received from a customer as a pending order;
a screen display on which, when payment is made, said pending order recalled from said data storage;
an input device; and
a controller which, when said pending order is stored, stores first person-in-charge information identifying a person-in-charge associated with said pending order in said data storage in association with the pending order;
receives second person-in-charge information identifying an operator attempting to cause processing for displaying a list of said pending order stored in said data storage from the operator; and, when an instruction to execute said processing for displaying is issued, selects a pending order associated with said first person-in-charge information that matches said second person-in-charge information from said pending order stored in said data storage and displaying a list of the selected pending order on said screen display.

9. The sales processing apparatus according to claim 8, further comprising a sales data storage in which said pending data is stored as sales data by executing checkout processing for the said pending data.

10. A sales processing apparatus comprising:
storage means for storing an order received from a customer as a pending order;
display means on which, when payment is made, said pending order recalled from said data storage; and
control means which, when said pending order is stored, stores information identifying a person-in-charge associated with said pending order in said storage means in association with the pending order and, when an instruction to execute processing of said pending order stored in said storage means is issued, determines whether or not an operator who has issued the instruction to execute the processing matches the person-in-charge associated with said pending order and, if the operator matches the person-in-charge, enables execution of said processing.

11. The sales processing apparatus according to claim 10, further comprising sales data storage means in which said pending data is stored as sales data by executing checkout processing for the said pending data.

12. A recording medium which stores a program for a computer which performs processing for storing an order received from a customer in a data storage as a pending order, recalling said pending order from said data storage to display said pending order on a screen display when payment is made, and executing checkout processing to book said pending order as sales data, said program causing the computer to perform the processing of:
when said pending order is stored, storing information identifying a person-in-charge associated with said pending order in said data storage in association with the pending order; and,
when an instruction to execute processing of said pending order stored in said data storage is issued, determining whether or not an operator who has issued the instruction to execute the processing matches the person-in-charge associated with said pending order and, if the operator matches the person-in-charge, enabling execution of said processing.
